(19) United States
(12) Patent Application Publication
(10) Pub. No.: US 2022/0013877 A1
(43) Pub. Date: Jan. 13, 2022

(54) SWITCH DEVICE

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 17/429,128

(22) PCT Filed: Mar. 10, 2020
(86) PCT No.: PCT/JP2020/010226

§ 371 Date: Aug. 6, 2021

(30) Foreign Application Priority Data
Mar. 14, 2019 (JP) 2019-047557

(51) Int. Cl. H01P 1/12; H01P 3/127; H01P 1/26

(52) U.S. Cl. CPC H01P 1/122; H01P 1/262; H01P 3/127

(57) ABSTRACT

Provided is a switch device that can be used in a millimeter wave band and that can exhibit both low loss and high isolation characteristics. This switch device (1) includes: a post-wall waveguide (filter main body 1M) in which openings (AP1 to AP5) are formed in a broad wall (conductor layer 2); a cover (5) including a portion that blocks the openings (AP1 to AP5), the portion being made of an electrically conductive material; and a cover control mechanism (actuator 6) that switches between a first state in which the openings (AP1 to AP5) are blocked by the cover (5) and a second state in which the openings (AP1 to AP5) are open.

### TECHNICAL FIELD

The present invention relates to a switch device that includes a post-wall waveguide in which an electromagnetic wave is guided and that switches between a first state in which the electromagnetic wave is guided and a second state in which the electromagnetic wave is not guided.

### BACKGROUND ART

Non-patent literatures 1 to 3 each disclose a switch device that can be used in a band of millimeter waves (hereinafter referred to as “millimeter wave band”).

Non-patent Literature 1 mentions a switch device which is part of a monolithic microwave integrated circuit (MMIC). The switch device having a product name “SP4T” described in Non-Patent Literature 1 has a loss and an isolation of 2.8 dB and 16.7 dB, respectively, in a band of 59.2 GHz to 60.1 GHz. The loss of 2.8 dB is a relatively large loss, and the switch device has room for further reduction in loss.

Non-patent literature 2 discloses a switch device that is formed of a PIN diode and that can be used in the millimeter wave band. It is difficult for a switch device formed of a PIN diode to have increased isolation characteristics in the millimeter wave band. A typical switch device that is formed of a PIN diode has an isolation of less than 10 dB in a 50 GHz band.

Further, examples of a PIN diode that can be used to form the foregoing switch device include a PIN diode disclosed in Non-patent Literature 3.

### CITATION LIST

### Non-Patent Literature

[Non-patent Literature 1]

“Kokunai hatsu, miriha tsushin shisutem no jitsugen ni muke hitsuyo na handotai kairo wo subete MMIC ka miriha sojushin mojyuru yo GaAs MMIC chippu setto wo kaihatsu (GaAs MMIC chip sets for millimeter wave transmitter-receiver modules developed; first in Japan to use MMIC circuits as all necessary semiconductor circuits, aiming to develop a millimeter wave communication system)”, [online], Feb. 25, 2009, [searched on Dec. 5, 2018], Internet <URL: http://mitsubishielectric.co.jp/news-data/2009/pdf/0225.pdf>

[Non-patent Literature 2]

“THE PIN DIODE CIRCUIT DESIGNERS' HANDBOOK”, [online], 1998, [searched on Dec. 5, 2018], Internet <URL: https://www.ieee.li/pdf/essay/pin_diode_handbook.pdf#se arch=%27THE+PIN+DIODE+CIRCUIT+DESIGNERS%E2%80% 99%27>

[Non-patent Literature 3]

“MA4AGP907 MA4AGFCP910 AlGaAs Flip Chip PIN Diodes”, [searched on Dec. 5, 2018], Internet <URL: https://cdn.macom.com/datasheets/MA4AGP907_FCP910.pdf#search=%27MA4AGFCP910%27>

### SUMMARY OF INVENTION

### Technical Problem

However, as described above, the switch device which is part of the MMIC disclosed in Non-Patent Literature 1 has significant loss (2.8 dB), and the switch device formed of the PIN diode disclosed in Non-Patent Literature 2 has poor isolation (less than 10 dB) in the millimeter wave band.

The present invention was made in view of the above issues, and an objective thereof is to provide a switch device that can be used in a millimeter wave band and that can exhibit both low loss and high isolation characteristics.

### Solution to Problem

In order to attain the objective, a switch device in accordance with an aspect of the present invention is a switch device, including: a post-wall waveguide that includes: a dielectric substrate; a first conductor layer and a second conductor layer that are a pair of broad walls and provided on a first main surface and a second main surface, respectively, of the dielectric substrate; and a post wall that passes through the dielectric substrate and is constituted by a conductor post group which is a plurality of conductor posts arranged in a palisade arrangement and via which the first conductor layer and the second conductor layer are in electrical communication with each other, a waveguide region being formed by the first conductor layer, the second conductor layer, and a part of the dielectric substrate which part is surrounded by the post wall; at least one opening formed in one or both of the pair of broad walls; a cover including a portion that blocks the at least one opening, the portion being made of an electrically conductive material; and a cover control mechanism that controls a position of the cover so as to switch between a first state in which all of the at least one opening are blocked by the cover and a second state in which all of the at least one opening are open.

### Advantageous Effects of Invention

A switch device in accordance with an aspect of the present invention makes it possible to provide a switch device that can be used in a millimeter wave band and that can exhibit both low loss and high isolation characteristics.

### BRIEF DESCRIPTION OF DRAWINGS

FIG. 1 is a perspective view illustrating a switch device in accordance with an embodiment of the present invention, the switch device being in a second state.

FIG. 2 is an exploded perspective view of a switch device in accordance with an embodiment of the present invention.

FIG. 3 is a plan view schematically illustrating contours of five resonators of a filter included in the switch device illustrated in FIG. 1.

FIG. 4 is a perspective view of a switch device that is Variation 1 of the present invention.

FIG. 5 is a perspective view of a switch device that is Variation 2 of the present invention.

FIG. 6 is a perspective view of a switch device that is Variation 3 of the present invention.

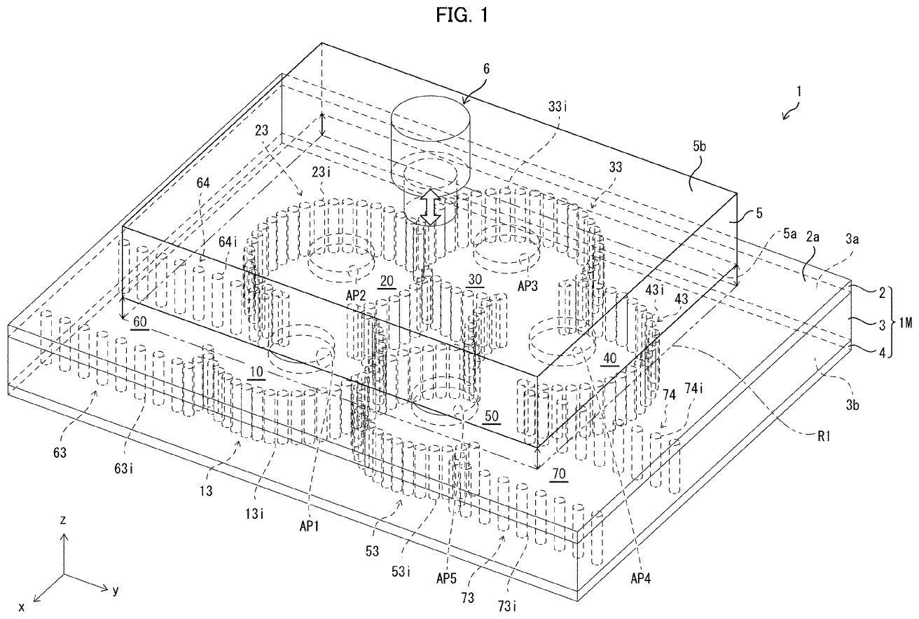

(a) of FIG. 7 is a chart showing respective transmission characteristics of an Example of the switch device illustrated in FIG. 1 in a first state and a second state. (b) of FIG. 7 is a chart showing an enlarged view of the chart shown in (a) of FIG. 7.

### DESCRIPTION OF EMBODIMENTS

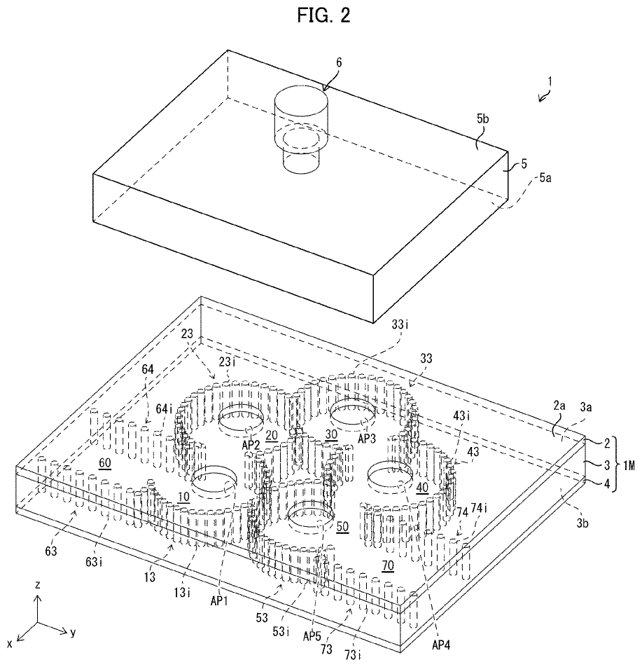

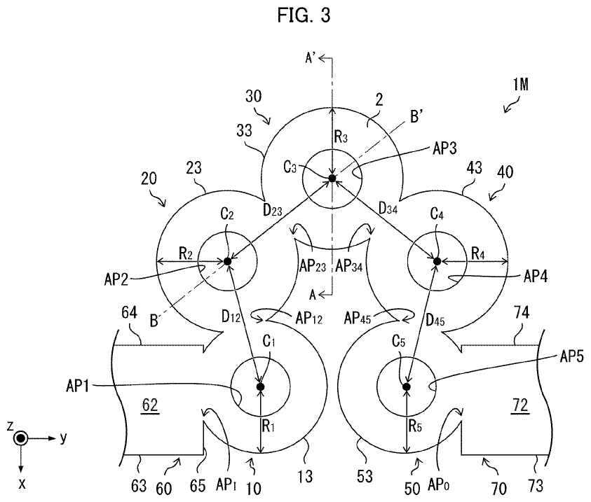

The following description will discuss a switch device 1 in accordance with an embodiment of the present invention with reference to FIGS. 1 to 3. FIG. 1 is a perspective view of the switch device 1 in a second state. FIG. 2 is an exploded perspective view of the switch device 1. FIG. 3 is a plan view schematically illustrating contours of five resonators 10, 20, 30, 40, and 50 of a filter main body 1M included in the switch device 1. Note that, in FIG. 3, post walls 13, 23, 33, 43, 53, 63, 64, 73, and 74, each of which is constituted by a conductor post group, are each illustrated in the form of an imaginary continuous conductor wall.

As illustrated in FIGS. 1 and 2, the switch device 1 includes the filter main body 1M, a cover 5, and an actuator 6. The filter main body 1M includes a conductor layer 2, a dielectric substrate 3, a conductor layer 4, and the post walls 13, 23, 33, 43, 53, 63, 64, 73, and 74.

The dielectric substrate 3 is made of quartz glass in the embodiment.

In the embodiment, the conductor layer 2 is a conductor layer made of copper and provided on a first main surface 3a which is a main surface of the dielectric substrate 3 and which is positioned downstream in the positive z axis direction. In the embodiment, the conductor layer 4 is a conductor layer made of copper and provided on a second main surface 3b which is a main surface of the dielectric substrate 3 and which is positioned downstream in the negative z axis direction.

Each of the post walls 13, 23, 33, 43, 53, 63, 64, 73, and 74 passes through the dielectric substrate 3 and consists of a conductor post group which is constituted by a plurality of conductor posts via which the conductor layer 2 and the conductor layer 4 are in electrical communication with each other. As illustrated in FIGS. 1 and 2, the post wall 13 is constituted by a plurality of conductor posts 13i (i is a positive integer).

The conductor posts 13i are formed by forming through-holes that pass through the dielectric substrate 3 from the first main surface 3a to the second main surface 3b and then forming a conductor layer on an inner wall of each of the through-holes. Note that the conductor posts 13i may be formed by filling the through-holes with a conductor.

As with the post wall 13, the post walls 23, 33, 43, 53, 63, 64, 73, and 74 are respectively constituted by pluralities of conductor posts 23i, 33i, 43i, 53i, 63i, 64i, 73i, and 74i which are each arranged in a palisade arrangement.

Each of the post walls 13, 23, 33, 43, 53, 63, 64, 73, and 74, which is constituted by a plurality of conductor posts arranged at certain intervals in a palisade arrangement, functions as a kind of conducting wall that reflects electromagnetic waves within a band that depends on the certain intervals.

[Filter Main Body 1M]

As illustrated in FIGS. 1 to 3, the filter main body 1M includes the resonators 10, 20, 30, 40, and 50 and waveguides 60 and 70. Each of these resonators 10, 20, 30, 40, and 50 and waveguides 60 and 70 is a post-wall waveguide which is formed by: a part of the conductor layer 2 and a part of the conductor layer 4 serving as a pair of broad walls; and a corresponding one(s) of the post walls 13, 23, 33, 43, 53, 63, 64, 73, and 74 serving as a narrow wall(s), and in which a region surrounded by the pair of broad walls and the narrow wall(s) functions as a waveguide region.

For example, the post wall 13 of the resonator 10 is constituted by the plurality of conductor posts 13i arranged in a circle in a palisade arrangement. Similarly, the post walls 23, 33, 43, and 53 of the resonators 20, 30, 40, and 50 are respectively constituted by the pluralities of conductor posts 23i, 33i, 43i, and 53i each arranged in a circle in a palisade arrangement, and the post walls 63, 64, 73, and 74 of the waveguides 60 and 70 are respectively constituted by the pluralities of conductor posts 63i, 64i, 73i, and 74i each arranged in a straight line in a palisade arrangement.

As a result, for example, a main resonance region of the resonator 30 is constituted by a part of the conductor layer 2, a part of the conductor layer 4, and a part of the dielectric substrate 3 surrounded by the post wall 33. Similarly, a main resonance region of each of the resonators 10, 20, 40, and 50 is constituted by a part of the conductor layer 2, a part of the conductor layer 4, and a part of the dielectric substrate 3 surrounded by a corresponding one of the post walls 13, 23, 43, and 53.

Note that the conductor layer 2 has a circular opening AP1 in a region that includes a center C₁ of a region that functions as a broad wall of the resonator 10 (see FIG. 3). Similarly, the conductor layer 2 has: a circular opening AP2 in a region that includes a center C₂ of a region that functions as a broad wall of the resonator 20; a circular opening AP3 in a region that includes a center C₃ of a region that functions as a broad wall of the resonator 30; a circular opening AP4 in a region that includes a center C₄ of a region that functions as a broad wall of the resonator 40; and a circular opening AP5 in a region that includes a center C₅ of a region that functions as a broad wall of the resonator 50. Therefore, the conductor layer 2 is an example of “one of the pair of broad walls” recited in the Claims, and also an example of the “first conductor layer” recited in the Claims.

The waveguide 60 and the resonator 10 are electromagnetically coupled together via a coupling window AP_{I}. The resonator 10 and the resonator 20 are electromagnetically coupled together via a coupling window AP₁₂. The resonator 20 and the resonator 30 are electromagnetically coupled together via a coupling window AP₂₃. The resonator 30 and the resonator 40 are electromagnetically coupled together via a coupling window AP₃₄. The resonator 40 and the resonator 50 are electromagnetically coupled together via a coupling window AP₄₅. The resonator 50 and the waveguide 70 are electromagnetically coupled together via a coupling window AP_{O}.

The coupling window AP₁₂ is formed by missing one(s) of the conductor posts 13i and one(s) of the conductor posts 23i. The coupling windows AP₂₃, AP₃₄, AP₄₅, AP_{I}, and AP_{O} are each formed in a similar fashion.

In the filter main body 1M, each of the coupling windows AP_{I} and AP_{O} functions as an input-output port. When the coupling window AP_{I} serves as an input port, the coupling window AP_{O} serves as an output port, whereas, when the coupling window AP_{O} serves as an input port, the coupling window AP_{I} serves as an output port. Either of the input-output ports can be used as an input port.

As described above, the filter main body 1M is a filter in which the post-wall waveguides are used. The filter main body 1M is a five-pole, resonator-coupled filter in which the five resonators 10, 20, 30, 40, and 50 are electromagnetically coupled. The switch device 1 including the filter main body 1M thus arranged functions as a band-pass filter.

Note that although the five-pole, resonator-coupled filter is employed in the embodiment as the filter main body 1M, the number of poles of the filter main body 1M does not necessarily need to be five but can be selected as appropriate depending on the desired filter characteristics.

(Center-to-Center Distance Between Resonators)

As illustrated in FIG. 3, the radius of each of the broad walls forming the resonator 10 is referred to as R₁, the radius of each of the broad walls forming the resonator 20 is referred to as R₂, the radius of each of the broad walls forming the resonator 30 is referred to as R₃, the radius of each of the broad walls forming the resonator 40 is referred to as R₄, and the radius of each of the broad walls forming the resonator 50 is referred to as R₅. Furthermore, the distance between the center C₁ and the center C₂ is referred to as D₁₂, the distance between the center C₂ and the center C₃ is referred to as D₂₃, the distance between the center C₃ and the center C₄ is referred to as D₃₄, and the distance between the center C₄ and the center C₅ is referred to as D₄₅.

In the above arrangement, the radius R₁, the radius R₂, and the distance D₁₂ satisfy the condition D₁₂<R₁+R₂, the radius R₂, the radius R₃, and the distance D₂₃ satisfy the condition D₂₃<R₂+R₃, the radius R₃, the radius R₄, and the distance D₃₄ satisfy the condition D₃₄<R₃+R₄, and the radius R₄, the radius R₅, and the distance D₄₅ satisfy the condition D₄₅<R₄+R₅. Provided that such a condition is satisfied, two adjacent resonators (for example, the resonator 10 and the resonator 20) can be electromagnetically coupled to each other via a coupling window in the narrow walls of the resonators (for example, via the coupling window AP₁₂).

(Symmetry of Two Adjacent Resonators)

Of the plurality of resonators 10, 20, 30, 40, and 50 in the filter main body 1M, a focus is placed on two adjacent resonators coupled to each other. The following description is based on the resonator 20 and the resonator 30. The shape of a combination of each of the broad walls of one of the two resonators 20 and 30 and each of the broad walls of the other of the two resonators 20 and 30 is symmetric with respect to line BB′ that connects the centers C₂ and C₃ together (see FIG. 3). As such, the degree of symmetry of the two resonators coupled to each other in the filter main body 1M is high. This makes it possible to reduce the number of design parameters. Thus, the filter main body 1M makes it possible to easily design a filter with desired characteristics.

Note that, in the filter main body 1M, not only two resonators coupled to each other but also the switch device 1 as a whole is symmetric with respect to a line. Specifically, the resonators 10 to 50 are arranged such that they are symmetric with respect to a line that is parallel to the x axis and that passes through the center C₃ of the region that functions as broad walls of the resonator 30, and the waveguides 60 and 70 are arranged such that they are symmetric with respect to that line. As such, the filter main body 1M has a high degree of symmetry also concerning the shape of the filter main body 1M as a whole. This makes it possible to further reduce the number of design parameters. Thus, the filter main body 1M makes it possible to more easily design a bandpass filter with desired characteristics.

(Arrangement of Resonators 10 and 50)

In the filter main body 1M, the resonator 10 and the resonator 50 are arranged so as to be adjacent to each other (see FIG. 3). Therefore, the total length of the filter main body can be reduced as compared to when a plurality of resonators are arranged in a straight line. A reduction in total length of the filter main body makes it possible to reduce the absolute value of thermal expansion or thermal contraction that would result from a change in ambient temperature around the filter main body 1M. As such, the filter main body 1M, whose total length is shorter than that of the conventional filter main body, is capable of reducing changes in center frequency of a passband, bandwidth, and the like that would result from changes in ambient temperature. In other words, the characteristics of the filter main body 1M are highly stable to changes in ambient temperature.

(Shapes of Resonators)

As illustrated in FIGS. 1 to 3, in the resonators 10, 20, 30, 40, and 50 of the filter main body 1M, the pluralities of conductor posts 13i, 23i, 33i, 43i, and 53i of the post walls 13, 23, 33, 43, and 53 serving as narrow walls are each arranged in a palisade arrangement along the circle when the first main surface 3a is seen in a plan view. Note that each of the pluralities of conductor posts 13i, 23i, 33i, 43i, and 53i may be arranged in a palisade arrangement along a regular polygon with six or more vertices instead of the circle.

[Cover 5 and Actuator 6]

The cover 5 blocks the openings AP1 to AP5 in a case where a part of a surface of the cover 5 is in contact with a surface 2a of the conductor layer 2, and at least a portion of the cover 5 which portion blocks the openings AP1 to AP5 is made of an electrically conductive material. One end of the actuator 6 (described later) is joined to a surface 5b that is part of the surface of the cover 5 and that faces away from the filter main body 1M.

The actuator 6 is an example of the “cover control mechanism” recited in the Claims and controls the position of the cover 5 so as to switch between a first state in which the openings AP1 to AP5 are blocked by the cover 5 and a second state in which the openings AP1 to AP5 are open.

Among flat surfaces constituting the surface of the cover 5, a flat surface that blocks the openings AP1 to AP5 by coming into contact with the conductor layer 2 in the first state will hereinafter be referred to as a specific surface 5a. The specific surface 5a is an example of the “portion that blocks the at least one opening” recited in the Claims. A region R₁ indicated with dot-dot-dash lines in FIG. 1 is a region on the surface 2a of the conductor layer 2 with which region the specific surface 5a comes in contact in the first state.

In the embodiment, the cover 5 is a block-shaped member at least a part of which, including the specific surface 5a, is made of a conductor. The cover 5 may be constituted by a block-shaped member whose entirety is made of a conductor.

Note that the cover 5 is not limited to the one in the embodiment. For example, the cover 5 may be a block-shaped member that is made of an electrically nonconductive resin or ceramic and that has an electrically conductive plate-shaped or layer-shaped member joined to a portion of the block-shaped member which portion serves as the specific surface 5a.

Note that in the embodiment, examples of the electrically conductive material of the block-shaped member that is made of a conductor and constitutes the cover 5 include a metal such as an aluminum alloy and copper.

In the embodiment, the cover 5 is the block-shaped member at least a part of which, including the specific surface 5a, is made of a conductor. In an aspect of the present invention, the cover 5 may be a plate-shaped member at least a part of which, including the specific surface 5a, is made of a conductor.

In the embodiment, the actuator 6 is capable of increasing and reducing, in a uniaxial direction (in the embodiment, along the z axis), the total length of the actuator 6 as measured along the z axis shown in FIG. 1.

As illustrated in FIG. 1, the actuator 6 spaces the specific surface 5a and the surface 2a apart from each other by reducing the total length of the actuator 6. In this case, the switch device 1 is in the second state in which the openings AP1 to AP5 are open. The distance between the specific surface 5a and the surface 2a in the second state is not particularly limited, and can be set as appropriate within a range that allows isolation characteristics between an input port and an output port to satisfy desired isolation characteristics. For example, as illustrated in FIG. 7, in a case where the distance between a specific surface 5a and a surface 2a is set to 1 mm in a switch device 1 of an Example, S-parameter S(2, 1) between an input port and an output port is less than −35 dB in an operation band. Thus, in the switch device 1 of the Example, good isolation characteristics can be obtained by setting the distance between the specific surface 5a and the surface 2a in the second state to 1 mm.

Though not illustrated, the actuator 6 brings the specific surface 5a and the surface 2a in contact with each other by increasing the total length of the actuator 6. In this case, the switch device 1 is in the first state in which the openings AP1 to AP5 are blocked by the specific surface 5a.

Note that, in the embodiment, the actuator 6 is configured to increase and decrease, along the z axis, the total length of the actuator 6 so as to move the position of the cover 5 along the z axis. However, the direction in which the actuator 6 increases and decreases the total length of the actuator 6 does not necessarily need to be along the z axis, but can be along the x axis, along the y axis, or along any one axis in the x-y plane. In these cases, the actuator 6 only needs to be configured to (1) move the cover 5, in the first state, to such a position that the specific surface 5a blocks all of the openings AP1 to AP5 and (2) move (evacuate) the cover 5, in the second state, to such a position that the specific surface 5a overlaps with none of the openings AP1 to AP5.

(Number of Resonators Having Opening)

In the above description of the embodiment, the resonators 10, 20, 30, 40, and 50 of the filter main body 1M have the respective openings AP1, AP2, AP3, AP4, and AP5 formed in the conductor layer 2. However, in an aspect of the present invention, which one(s) of the resonators 10, 20, 30, 40, and 50 of the filter main body 1M has/have an opening formed in the conductor layer 2 can be determined as appropriate. In an aspect of the present invention, the number of resonators having an opening may be one, or may be more than one.

For example, in a case where each of the resonators 20, 30, and 40 among the resonators 10, 20, 30, 40, and 50 of the filter main body 1M has an opening, it is only necessary that the openings AP2, AP3, and AP4 be formed in the conductor layer 2 and that the cover 5 be configured such that the specific surface 5a contains at least the openings AP2, AP3, and AP4 when the conductor layer 2 is seen in a plan view.

(Conductor layer in which opening is formed) In the above description of the embodiment, the filter main body 1M is configured such that the openings AP1, AP2, AP3, AP4, and AP5 are each formed in a part of the conductor layer 2 (first conductor layer) which part constitutes one of the broad walls of a corresponding one of the resonators 10, 20, 30, 40, and 50.

However, in an aspect of the present invention, each of the openings AP1, AP2, AP3, AP4, and AP5 needs only be formed in one of a part of the conductor layer 2 (first conductor layer) and a part of the conductor layer 4 (second conductor layer) which parts constitute the pair of broad walls of a corresponding one of the resonators 10, 20, 30, 40, and 50. For example, all of the openings AP1, AP2, AP3, AP4, and AP5 may be formed in the conductor layer 4 (second conductor layer). Alternatively, one(s) (for example, the openings AP1, AP2, and AP3) of the openings may be formed in the conductor layer 2, and the other one(s) (for example, AP4 and AP5) may be formed in the conductor layer 4. In a case of forming one(s) of the openings AP1, AP2, AP3, AP4, and AP5 in the conductor layer 4, the same arrangement as the cover 5 and the actuator 6 illustrated in FIGS. 1 and 2 may be provided on a conductor layer 4 side (positioned downstream in the negative z axis direction) with respect to the dielectric substrate 3 so as to correspond to the opening(s) formed in the conductor layer 4.

In the embodiment, the openings AP1, AP2, AP3, AP4, and AP5 are formed for the respective resonators 10, 20, 30, 40, and 50, in parts of the conductor layers which parts constitute the broad walls of the resonators 10, 20, 30, 40, and 50. However, the number of openings formed in parts of the conductor layers which parts constitute the broad walls of each resonator is not limited to one, and may be more than one. Further, the number of openings formed in parts of the conductor layers constituting the broad walls of each resonator may differ among the resonators.

[Variation 1]

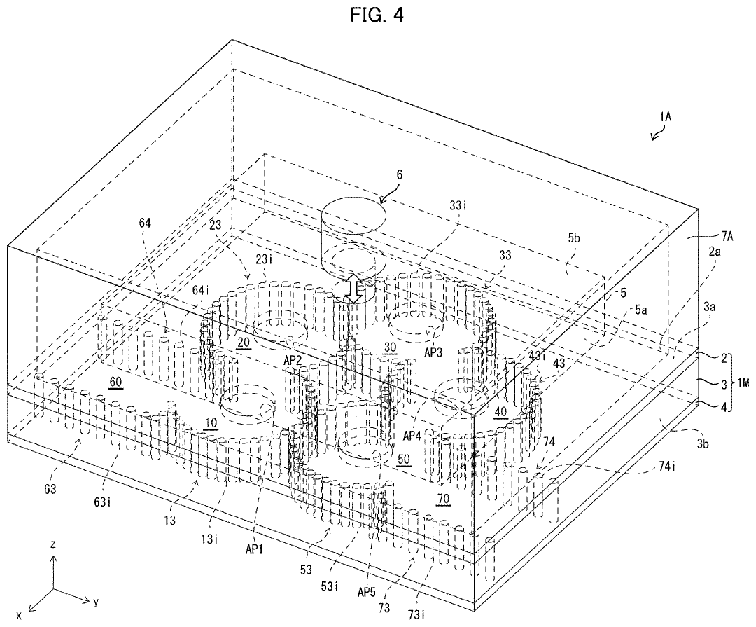

The following description will discuss, with reference to FIG. 4, a switch device 1A which is Variation 1 of the present invention and is a variation of the switch device 1 illustrated in FIGS. 1 to 3. FIG. 4 is a perspective view of the switch device 1A.

As illustrated in FIG. 4, the switch device 1A is different from the switch device 1 in that the switch device 1A further includes a shield 7A. As such, out of the members constituting the switch device 1A, members identical to members of the switch device 1 will be given identical reference signs, and description of such members will be omitted. That is, in Variation 1, description of a filter main body 1M, a cover 5, and an actuator 6 will be omitted, and description will be given only on the shield 7A.

The shield 7A is a housing that is made of a conductor and that covers a space containing openings AP1 to AP5 and the cover 5. In the embodiment, the shield 7A is a housing that has a rectangular parallelepiped outer shape and that has an open end face positioned downstream in the negative z axis direction shown in FIG. 4.

As illustrated in FIG. 4, the shield 7A covers the space containing the openings AP1 to AP5 and the cover 5, by being positioned such that the open end face is in contact with a surface 2a of a conductor layer 2.

The shield 7A only needs to cover at least the space containing the openings AP1 to AP5 and the cover 5, but as illustrated in FIG. 4, the shield 7A may cover a space containing the actuator 6 as well as the openings AP1 to AP5 and the cover 5.

The space containing the openings AP1 to AP5 and the cover 5 are preferably hermetically sealed by the shield 7A. Note, however, that the space containing the openings AP1 to AP5 and the cover 5 may be connected to the outside of the shield 7A via, for example, a gap formed in the shield 7A, a gap formed between the shield 7A and the surface 2a, and the like.

[Variation 2]

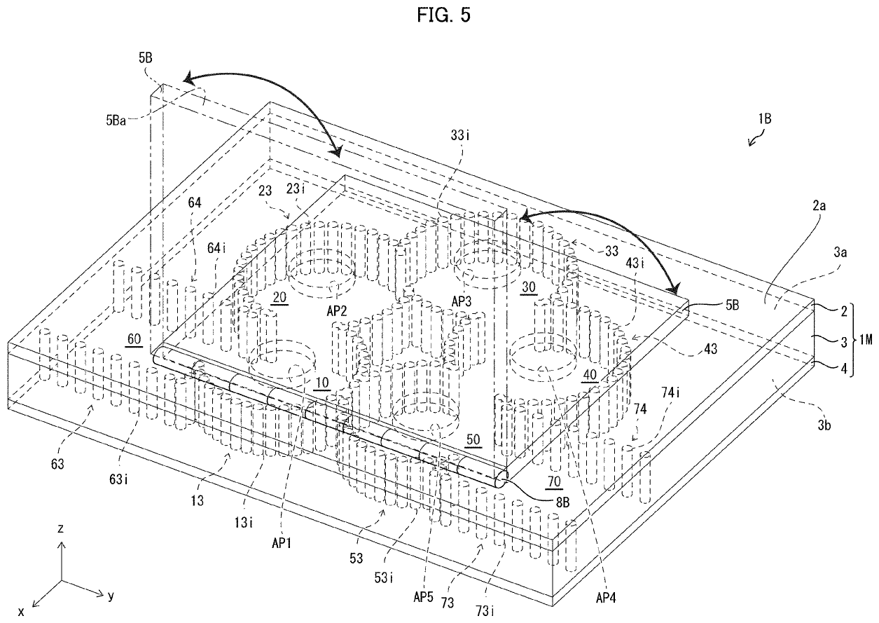

The following description will discuss, with reference to FIG. 5, a switch device 1B which is Variation 2 of the present invention and is a variation of the switch device 1 illustrated in FIGS. 1 to 3. FIG. 5 is a perspective view of the switch device 1B. In FIG. 5, a cover 5B positioned so as to bring the switch device 1B into a first state is shown with solid lines, and the cover 5B positioned so as to bring the switch device 1B into a second state is shown with dot-dot-dash lines.

As illustrated in FIG. 5, the switch device 1B includes a filter main body 1M, the cover 5B, a hinge 8B, and an actuator 6 which is not illustrated in FIG. 5. The filter main body 1M of the switch device 1B is identical to the filter main body 1M of the switch device 1. As such, out of the members constituting the switch device 1A, the filter main body 1M will be given an identical reference sign, and description of the filter main body 1M will be omitted. That is, in Variation 2, description will be given only on the cover 5B, the hinge 8B, and the actuator.

In Variation 2, the cover 5B blocks openings AP1 to AP5 in a case where a part of a surface of the cover 5B is in contact with a surface 2a of a conductor layer 2, and at least a portion of the cover 5B which portion blocks the openings AP1 to AP5 is made of an electrically conductive material. One end portion (in Variation 2, one edge side positioned downstream in the positive x axis direction illustrated in FIG. 4) of the cover 5B in the first state is directly secured via the hinge 8B to the surface 2a of the conductor layer 2, the surface 2a being a part of the switch device 1B.

Among flat surfaces constituting the surface of the cover 5B, a flat surface that blocks the openings AP1 to AP5 by coming into contact with the conductor layer 2 in the first state will hereinafter be referred to as a specific surface 5Ba.

The hinge 8B has an axis of rotation along the y axis illustrated in FIG. 4 and is capable of using the axis of rotation to change an angle between the specific surface 5Ba and the surface 2a of a first conductor layer (the conductor layer 2).

The actuator is an example of the “cover control mechanism” recited in the Claims, and controls the position of the cover 5B so as to switch between the first state in which the openings AP1 to AP5 are blocked by the cover 5B and the second state in which the openings AP1 to AP5 are open. The actuator controls the position (including orientation) of the cover 5B so as to change the angle between the specific surface 5Ba and the surface 2a of the conductor layer 2. The actuator brings the switch device 1B into the first state by moving the cover 5B so that the angle between the specific surface 5Ba and the surface 2a of the conductor layer 2 is 0°, and brings the switch device 1B into the second state by moving the cover 5B so that the angle between the specific surface 5Ba and the surface 2a of the conductor layer 2 is not less than a predetermined angle. In the switch device 1B in the second state illustrated in FIG. 5, the angle between the specific surface 5Ba and the surface 2a of the conductor layer 2 is 90°.

In Variation 2, the cover 5B is a plate-shaped member at least part of which, including the specific surface 5Ba, is made of a conductor. The cover 5B may be constituted by a plate-shaped member a whole of which is made of a conductor.

Note that the cover 5B is not limited to the one described in Variation 2, and may be a block-shaped member as the cover 5 illustrated in FIG. 1. Further, it is only necessary that at least a portion of the cover 5B which portion serves as the specific surface 5a is made of an electrically conductive material, and the rest of the cover 5B may be made of an electrically nonconductive resin or ceramic.

Note that in Variation 2, examples of the electrically conductive material of the block-shaped member that is made of a conductor and that constitutes the cover 5B include a metal such as an aluminum alloy and copper.

Note that in Variation 2, the one end portion of the cover 5B is directly secured via the hinge 8B to the surface 2a, which is a part of the switch device 1B. However, the one end portion of the cover 5B may be indirectly secured to a part of the switch device 1B via the hinge 8B and other members.

[Variation 3]

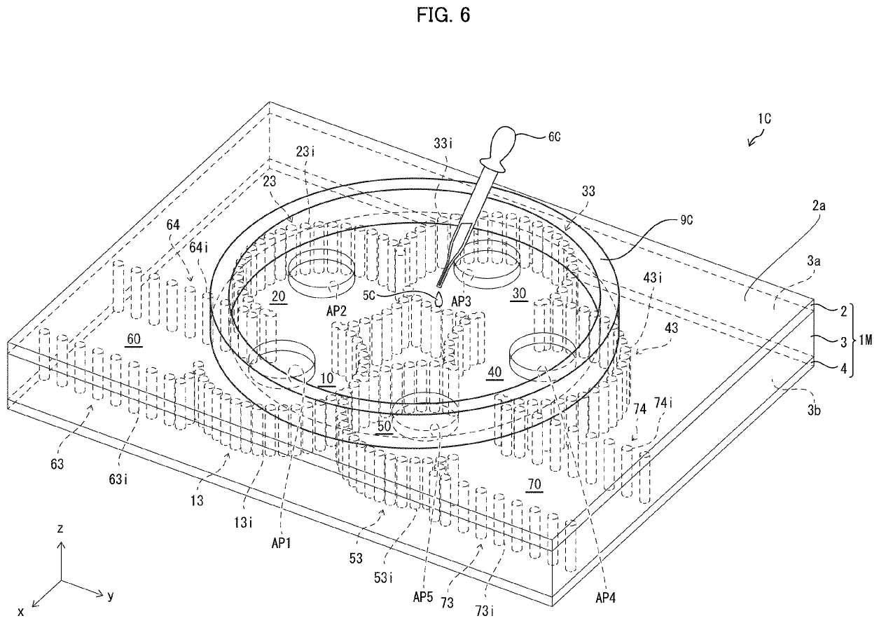

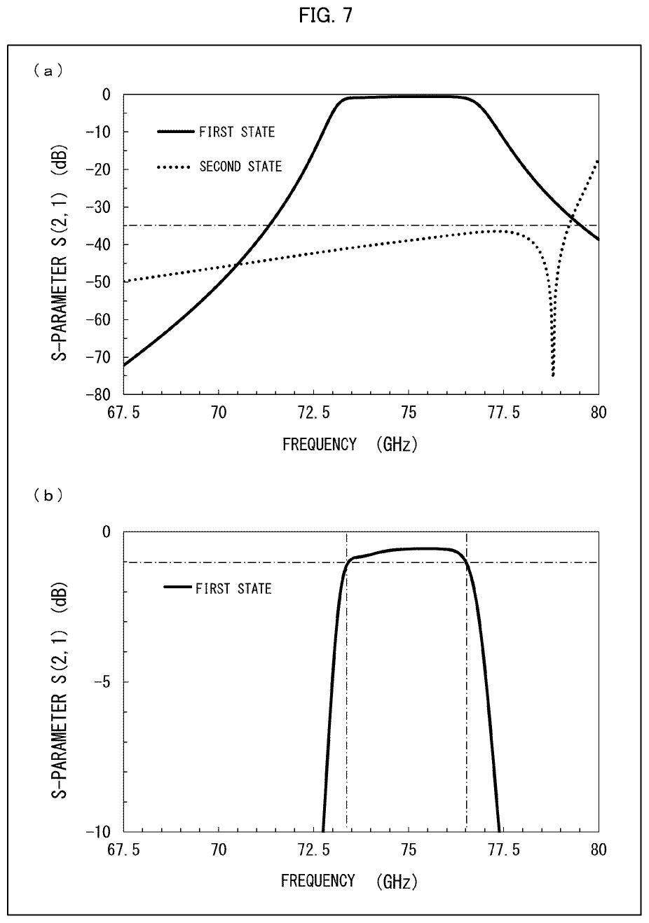

The following description will discuss, with reference to FIG. 6, a switch device 1C which is Variation 3 of the present invention and is a variation of the switch device 1 illustrated in FIGS. 1 to 3. FIG. 6 is a perspective view of the switch device 1C in a second state.

As illustrated in FIG. 6, the switch device 1C includes a filter main body 1M, a liquid metal 5C, a dropper 6C, and a frame 9C. The filter main body 1M of the switch device 1C is identical to the filter main body 1M of the switch device 1. As such, out of the members constituting the switch device 1C, the filter main body 1M will be given an identical reference sign, and description of the filter main body 1M will be omitted. That is, in Variation 3, description will be given only on the liquid metal 5C, the dropper 6C, and the frame 9C.

The liquid metal 5C is an example of the “cover” recited in the Claims, and is made of a material having fluidity as well as electrical conductivity. In Variation 3, the liquid metal 5C is made of mercury. Alternatively, the material of the liquid metal 5C may be any one of Galinstan (registered trademark), gallium, francium, and Metallium instead of mercury. Galinstan (registered trademark) is a eutectic alloy of gallium, indium, and tin. Other examples of the material having fluidity as well as electrical conductivity include a solvent in which an electrically conductive filler is dispersed.

The frame 9C is a closed annular frame that is provided on a surface 2a of a conductor layer 2 and that surrounds all of openings AP1 to AP5. The material of the frame 9C is not particularly limited. As described later, in a case where the liquid metal 5C is discharged from the dropper 6C to an inner side of the frame 9C, the frame 9C blocks the liquid metal 5C from flowing out of the switch device 1C. In the above description of Variation 3, the frame 9C collectively surrounds all of the openings AP1 to AP5. However, the present invention is not limited to such an aspect of a frame. For example, an aspect of a frame may be constituted by a set of five frames that individually and separately surround the respective openings AP1 to AP5, or may be constituted by a set of two frames one of which surrounds one(s) (for example, the openings AP1 to AP3) of the openings and the other of which surrounds the other opening(s) (for example, the openings AP4 to AP5).

The dropper 6C is an example of the “fluid pump” recited in the Claims, and also an example of the “cover control mechanism” recited in the Claims. The dropper 6C discharges and sucks the liquid metal 5C.

For example, the switch device 1C illustrated in FIG. 6 is in the second state in which the openings AP1 to AP5 are open. In the second state, in a case where the dropper 6C discharges a predetermined amount of the liquid metal 5C to the inner side of the frame 9C, the openings AP1 to AP5 are blocked by the liquid metal 5C. Thus, the switch device 1C is brought into the first state.

In the switch device 1C in the first state, in a case where the dropper 6C sucks the liquid metal 5C from the inner side of the frame 9C so as to expose the openings AP1 to AP5, the openings AP1 to AP5 become open. Thus, the switch device 1C is brought into the second state. In a case where the dropper 6C sucks the liquid metal 5C from the inner side of the frame 9C, the dropper 6C is preferably capable of moving as appropriate on the inner side of the frame 9C, in order to minimize the amount of the liquid metal 5C that is not sucked and remains on the inner side of the frame 9C.

As described above, the dropper 6C brings the switch device 1C from the first state to the second state or from the second state to the first state by moving the liquid metal 5C.

Note that the amount of the liquid metal 5C to be discharged by the dropper 6C in order to bring the switch device 1C from the second state to the first state is not particularly limited, and may be an amount that allows at least all of the openings AP1 to AP5 to be blocked.

### EXAMPLES

As an Example of the switch device 1 configured as illustrated in FIGS. 1 to 3, the diameter of each of the openings corresponding to the resonators 10, 20, 30, 40, and 50 (for example, the diameter of the opening AP3 in a case of the resonator 30) was set to 1000 μm.

Then, the frequency dependence of S-parameter S(2, 1) of the Example of the switch device 1 in the first state and the frequency dependence of S-parameter S(2, 1) of the Example of the switch device 1 in the second state were simulated. Hereinafter, frequency dependence of S-parameter S(2, 1) may also be referred to as transmission characteristics. Note that in the Example, the distance between the specific surface 5a of the cover 5 and the surface 2a of the conductor layer 2 in the first state was 0 mm, and the distance between the specific surface 5a and the surface 2a in the second state was 1 mm.

(a) of FIG. 7 is a chart showing respective transmission characteristics of the Example of the switch device 1 in the first state and the second state. (b) of FIG. 7 is a chart showing an enlarged view of the chart shown in (a) of FIG. 7.

With reference to (b) of FIG. 7, it was found that the S-parameter S(2, 1) of the Example of the switch device 1 in the first state was not less than −1 dB in a band of not less than 73.4 GHz and not more than 76.5 GHz. In other words, it was found that the Example of the switch device 1 in the first state can exhibit a low loss of not more than 1 dB in a case where a band of not less than 73.4 GHz and not more than 76.5 GHz, which is within the millimeter wave band, is used as an operation band.

Further, with reference to (a) of FIG. 7, it was found that the S-parameter S(2, 1) of the Example of the switch device 1 in the second state was less than −32.5 dB in a band of not more than 79.3 GHz. In other words, it was found that the Example of the switch device 1 in the second state can exhibit high isolation characteristics in the foregoing operation band, which is within the millimeter wave band.

Thus, it was found that the Example of the switch device 1 is a switch device that can be used in the millimeter wave band and that can exhibit both low loss and high isolation characteristics.

Aspects of the present invention can also be expressed as follows:

A switch device in accordance with an aspect of the present invention is a switch device, including: a post-wall waveguide that includes: a dielectric substrate; a first conductor layer and a second conductor layer that are a pair of broad walls and provided on a first main surface and a second main surface, respectively, of the dielectric substrate; and a post wall that passes through the dielectric substrate and is constituted by a conductor post group which is a plurality of conductor posts arranged in a palisade arrangement and via which the first conductor layer and the second conductor layer are in electrical communication with each other, a waveguide region being formed by the first conductor layer, the second conductor layer, and a part of the dielectric substrate which part is surrounded by the post wall; at least one opening formed in one or both of the pair of broad walls; a cover including a portion that blocks the at least one opening, the portion being made of an electrically conductive material; and a cover control mechanism that controls a position of the cover so as to switch between a first state in which all of the at least one opening are blocked by the cover and a second state in which all of the at least one opening are open.

In the first state of the switch device in accordance with an aspect of the present invention, all of the at least one opening formed in one or both of the pair of broad walls of the post-wall waveguide are blocked by the cover. As such, to an electromagnetic wave that propagates in the post-wall waveguide, the post-wall waveguide behaves as if there were no opening formed in the pair of broad walls. That is, in the first state, the switch device in accordance with an aspect of the present invention allows an electromagnetic wave, which has been coupled to one port, to pass to the other port.

In the second state of the switch device in accordance with an aspect of the present invention, all of the at least one opening are open, so that the impedance-matching state of the post-wall waveguide is disrupted. As such, an electromagnetic wave that has propagated from one port of the post-wall waveguide to the at least one opening is either reflected due to the foregoing impedance mismatch, or leaks out of the post-wall waveguide through the at least one opening. Thus, in the second state, the switch device in accordance with an aspect of the present invention blocks an electromagnetic wave coupled to one port, instead of allowing the electromagnetic wave to pass to the other port.

Further, the switch device in accordance with an aspect of the present invention has less loss than the switch device which is part of the MMIC disclosed in Non-Patent Literature 1, and has higher isolation than the switch device formed of the PIN diode disclosed in Non-Patent Literature 2. Therefore, the switch device in accordance with an aspect of the present invention is a switch device that can be used in the millimeter wave band and that can exhibit both low loss and high isolation.

A switch device in accordance with an aspect of the present invention is preferably configured such that: the post-wall waveguide includes, at least in a partial section of the post-wall waveguide, a plurality of resonators electromagnetically coupled together via a coupling window; and each of the at least one opening is formed in a part of one or both of the pair of broad walls which part corresponds to at least one of the plurality of resonators.

With the configuration, the switch device in accordance with an aspect of the present invention not only has the function of switching between the first state and the second state but also functions as a bandpass filter which sets a partial band to be a passband in the first state.

A switch device in accordance with an aspect of the present invention may be configured such that each of the at least one opening is formed in a part of one or both of the pair of broad walls which part corresponds to all of the plurality of resonators.

A switch device in accordance with an aspect of the present invention is preferably configured such that the at least one opening is formed only in one of the pair of broad walls.

With the configuration, the switch device in accordance with an aspect of the present invention is simple in configuration.

A switch device in accordance with an aspect of the present invention may be configured such that the portion of the cover which portion blocks the at least one opening is a plate-shaped or block-shaped member made of a conductor.

A switch device in accordance with an aspect of the present invention may be configured such that the cover control mechanism is an actuator that moves the cover in a uniaxial direction.

A switch device in accordance with an aspect of the present invention may be configured such that the uniaxial direction is a direction perpendicular to the at least one opening.

A switch device in accordance with an aspect of the present invention may be configured such that the uniaxial direction is a direction parallel to the at least one opening.

A switch device in accordance with an aspect of the present invention may be configured such that: one end portion of the cover is directly or indirectly secured to a part of the switch device via a hinge; and the cover control mechanism is an actuator that changes an angle between the portion and the at least one opening.

In a case where a plate-shaped or block-shaped member made of a conductor is employed as the portion of the cover which portion blocks the at least one opening, the cover control mechanism of the switch device in accordance with an aspect of the present invention can be provided in the form of an actuator that moves the cover in a uniaxial direction or an actuator that changes the angle between the foregoing portion of the cover and the at least one opening.

A switch device in accordance with an aspect of the present invention may be configured such that the switch device further includes a frame that is provided on the one of the pair of broad walls and that surrounds all of the at least one opening collectively or separately, wherein the cover is made of a material having fluidity as well as electrical conductivity and is positioned on an inner side of the frame in the first state; and the cover control mechanism is a fluid pump that switches between the first state and the second state by moving the cover.

With the configuration, even in a case where the cover is made of a material having fluidity as well as electrical conductivity, it is possible to block or open the at least one opening with use of the cover.

A switch device in accordance with an aspect of the present invention is preferably configured such that the switch device further includes a shield that is made of a conductor and that covers a space containing the at least one opening and the cover.

In the second state of the switch device in accordance with an aspect of the present invention, the at least one opening is open. As such, an electromagnetic wave that has propagated from one port to the at least one opening is either reflected at the at least one opening or leaks out of the waveguide through the at least one opening. With the configuration, the shield made of a conductor covers the space containing the at least one opening and the cover. As such, in a case where an electromagnetic wave is likely to leak out of the waveguide through the at least one opening, it is possible to prevent the electromagnetic wave from leaking out of the switch device in accordance with an aspect of the present invention.

Supplementary Note

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1A, 1B, 1C: switch device
1M: filter main body (post-wall waveguide)
2: conductor layer (first conductor layer, one of a pair of broad walls)
AP1 to AP5: opening
3: dielectric substrate
3a, 3b: first main surface, second main surface
4: conductor layer (second conductor layer)
5, 5B: cover
5a, 5Ba: specific surface
5C: liquid metal (cover)
6: actuator (cover control mechanism)
6C: dropper (fluid pump, cover control mechanism)
7A: shield
8B: hinge
9C: frame
10, 20, 30, 40, 50: resonator
13, 23, 33, 43, 53: post wall
AP12, AP23, AP34, AP45: coupling window

1. A switch device, comprising:
a post-wall waveguide that includes:
a dielectric substrate;
a first conductor layer and a second conductor layer that are a pair of broad walls and provided on a first main surface and a second main surface, respectively, of the dielectric substrate; and
a post wall that passes through the dielectric substrate and is constituted by a conductor post group which is a plurality of conductor posts arranged in a palisade arrangement and via which the first conductor layer and the second conductor layer are in electrical communication with each other, a waveguide region being formed by the first conductor layer, the second conductor layer, and a part of the dielectric substrate which part is surrounded by the post wall;
at least one opening formed in one or both of the pair of broad walls;
a cover including a portion that blocks the at least one opening, the portion being made of an electrically conductive material; and
a cover control mechanism that controls a position of the cover so as to switch between a first state in which all of the at least one opening are blocked by the cover and a second state in which all of the at least one opening are open.

2. The switch device as set forth in claim 1, wherein:
the post-wall waveguide includes, at least in a partial section of the post-wall waveguide, a plurality of resonators electromagnetically coupled together via a coupling window; and
each of the at least one opening is formed in a part of one or both of the pair of broad walls which part corresponds to at least one of the plurality of resonators.

3. The switch device as set forth in claim 2, wherein each of the at least one opening is formed in a part of one or both of the pair of broad walls which part corresponds to all of the plurality of resonators.

4. The switch device as set forth in claim 1, wherein the at least one opening is formed only in one of the pair of broad walls.

5. The switch device as set forth in claim 1, wherein the portion of the cover which portion blocks the at least one opening is a plate-shaped or block-shaped member made of a conductor.

6. The switch device as set forth in claim 1, wherein the cover control mechanism is an actuator that moves the cover in a uniaxial direction.

7. The switch device as set forth in claim 6, wherein the uniaxial direction is a direction perpendicular to the at least one opening.

8. The switch device as set forth in claim 6, wherein the uniaxial direction is a direction parallel to the at least one opening.

9. The switch device as set forth in claim 1, wherein:
one end portion of the cover is directly or indirectly secured to a part of the switch device via a hinge; and
the cover control mechanism is an actuator that changes an angle between the portion and the at least one opening.

10. The switch device as set forth in claim 4, further comprising a frame that is provided on the one of the pair of broad walls and that surrounds all of the at least one opening collectively or separately, wherein:
the cover is made of a material having fluidity as well as electrical conductivity and is positioned on an inner side of the frame in the first state; and
the cover control mechanism is a fluid pump that switches between the first state and the second state by moving the cover.

11. The switch device as set forth in claim 1, further comprising a shield that is made of a conductor and that covers a space containing the at least one opening and the cover.
